(19) United States
(12) Patent Application Publication
(10) Pub. No.: US 2013/0085751 A1
(43) Pub. Date: Apr. 4, 2013

(54) VOICE COMMUNICATION SYSTEM ENCODING AND DECODING VOICE AND NON-VOICE INFORMATION

(71) Applicant: Katsuyuki TAKAHASHI, Tokyo (JP)

(72) Inventor: Katsuyuki TAKAHASHI, Tokyo (JP)

(73) Assignee: OKI ELECTRIC INDUSTRY CO., LTD., Tokyo (JP)

(21) Appl. No.: 13/619,029

(22) Filed: Sep. 14, 2012

(30) Foreign Application Priority Data
Sep. 30, 2011 (JP) 2011-217070

(51) Int. Cl. G10L 19/00

(52) U.S. Cl. 704/205; 704/226; 704/E19.001

(57) ABSTRACT

In a voice coding apparatus of a voice communication system, feature parameters of background noise in background noise sections of an input signal stream are extracted and background noise is encoded into a comfortable-noise code, and embedding positions where additional information is to be embedded are determined according to the values of the extracted feature parameters. Additional information is embedded into the embedding positions thus determined of the voice or comfortable-noise code, which will be transmitted to a voice decoding apparatus in the system. In the decoding apparatus, the transmitted code is separated into voice and background noise sections to be decoded. From the background noise sections, the values of the feature parameters are found out and used to reference a correspondence relationship table to determine the embedding positions where the additional information is embedded. The additional information is extracted at the embedding positions thus determined to be restored.

### BACKGROUND OF THE INVENTION

1. Field of the Invention

The present invention relates to a voice communication system, and more in particular to a voice communication system for encoding voice and voice-related information including non-voice information with the non-voice information embedded and for decoding the voice and encoded voice-related information.

2. Description of the Background Art

In recent years, telecommunications systems have been developed which allow a larger amount of information to be transmitted while preventing the load on the communication lines from increasing. In order to implement such large-capacity information transmission, for example, packet communications systems may be adapted not only to assemble voice packets of telephonic speech signals but also to divide data of data files into file segments to embed the data of the file segments in the voice packets, which will in turn be received and disassembled on a receiving side into voice signals while restoring the data files.

Although the information-embedded packet transmissions are so useful, it is disadvantageous in that original information may be damaged by embedding additional information. It is therefore important to determine where in a data stream additional information is to be embedded with damage of the original information minimized. When original information to be transmitted is voice, this issue becomes particularly important. Because, part of voice waveforms or some parameters is possibly overwritten by additional information so as to affect the sound quality, rendering the quality of voice communication considerably deteriorating. Thus, there is a demand for a voice encoding system having a function of embedding additional information at optimum positions in a data stream where the deterioration of the quality of voice communication is minimized.

Examples of background art of embedding information with sound quality deterioration minimized are taught by European patent specification EP 1 333 424 B1 and Akira Nishimura, “Data hiding in pitch delay parameter in AMR speech codec”, Research Papers for Spring Meeting of the Acoustical Society of Japan, 3-6-10, pp. 1399-1402, (March 2009). According to those solutions, sound quality deterioration is minimized by, for example, making a decision as to whether or not the value of a pitch gain is smaller than a predetermined threshold to thereby determine whether or not the deterioration caused by embedding additional information would be small. If it is small, the additional information is embedded at predetermined embedding positions of data streams, thus minimizing deterioration in sound quality.

Adaptive Multi-Rates (AMRs) are regulated in the following four documents:

1) 3G TS 26.090 Version 3.1.0, AMR speech codec; Transcoding functions,
2) 3G TS 26.094 Version 3.0.0, AMR speech codec; Voice Activity Detector (VAD),
3) 3G TS 26.092 Version 3.0.1, AMR Speech Codec; Comfort noise aspects, and

### 4) 3GPP TS 26.101 Version 3.3.0, AMR Speech Codec Frame Structure.

In voice encoding systems based on ACELP (Algebraic Code Excited Linear Prediction) signals, embedding positions where the deterioration in sound quality is minimal differ in dependent upon the characteristics of background noise. Therefore, the conventional systems of embedding additional information at predetermined positions regardless of the noise characteristics raise the problem that deterioration in sound quality increases more than expected by the designers of the systems.

### SUMMARY OF THE INVENTION

It is therefore an object of the present invention to provide a voice communication system capable of minimizing deterioration in sound quality caused when transmitting a code stream having other data such as additional information embedded therein.

In accordance with the present invention, a voice coding apparatus encoding an input signal to generate a code and embedding additional information in the generated code comprises: a voice detector making a decision as to whether the input signal is in a voice section or in a background noise section and generating a switching signal associated with a result of the decision; a voice code generator generating a voice code based on the input signal in the voice section; a noise code generator operative in response to the input signal in the background noise section for extracting a noise feature parameter, which a voice decoder at a destination of the input signal uses to reconstruct the input signal in the background noise section, to encode the extracted parameter to thereby generate a noise code; a selector operative in response to the switching signal for switching the input signal between the voice code generator and the noise code generator; an embedding position controller determining an embedding position of the additional information according to the noise feature parameter extracted to control the embedding position; and an information embedder embedding the additional information at the embedding position of the voice code or noise code determined by the embedding position controller, the embedding position being set in advance according to a correspondence relationship with the noise feature parameter.

Also in accordance with the present invention, a voice decoding apparatus extracting additional information from a received code having the additional information embedded therein for restoring a signal intended by a voice coding apparatus at a transmission source comprises: a voice/noise section discriminator making a decision as to whether the received code is in a voice section or in a background noise section and generating a switching signal associated with a result of the decision; a voice decoder decoding a voice signal based on the received code in the voice section; a noise decoder obtaining a noise feature parameter based on the received code in the background noise section and generating a noise signal approximating a background noise characteristic of the voice coding apparatus; a selector operative in response to the switching signal for switching the received code between the voice decoder and the noise decoder; a signal reproducer outputting the voice signal and the noise signal obtained by the voice decoder and the noise decoder; a memory storing in advance a correspondence relationship between the noise feature parameter and an embedding position where the additional information is to be embedded; an embedding position collator supplying the obtained noise feature parameter as collation information to the memory and collating the embedding position of the additional information associated with the collation information; an additional-information extractor extracting a bit value lying at the embedding position collated with respect to the received code; and an additional-information reproducer forming the extracted bit values into a stream of bits to output the additional information.

Further in accordance with the present invention, a voice communication system is provided which comprises the voice coding apparatus and the voice decoding apparatus set forth above.

According to a voice communication system in accordance with the present invention, the information embedding positions in a signal stream to be transmitted where additional information is embedded are controlled according to the background noise characteristic of the signal stream, whereby deterioration in sound quality can be minimized and the communication bandwidth can be effectively utilized even when a code having additional information embedded therein is transmitted.

### BRIEF DESCRIPTION OF THE DRAWINGS

The objects and features of the present invention will become more apparent from consideration of the following detailed description taken in conjunction with the accompanying drawings in which:

FIG. 1 is a schematic block diagram of a telecommunications network system to which a voice communication system in accordance with the present invention is applied;

FIG. 2 is a schematic block diagram of an illustrative embodiment of transmitter included in the voice communication network system shown in FIG. 1 in accordance with the invention;

FIG. 3 is a schematic block diagram of a voice code generator included in the transmitter shown in FIG. 2;

FIG. 4 is a schematic block diagram of a comfortable-noise code generator included in the transmitter;

FIG. 5 is a schematic block diagram of an embedding position controller included in the transmitter;

FIGS. 6A and 6B illustrate the storage fields of a position memory in the embedding position controller shown in FIG. 5;

FIG. 7 is a schematic block diagram of a receiver included in the telecommunications network system shown in FIG. 1;

FIG. 8 is a schematic block diagram of an alternative embodiment of transmitter included in the voice communication system in accordance with the present invention; and

FIG. 9 is a schematic block diagram of an additional-information generator shown in FIG. 8.

### DESCRIPTION OF THE PREFERRED EMBODIMENTS

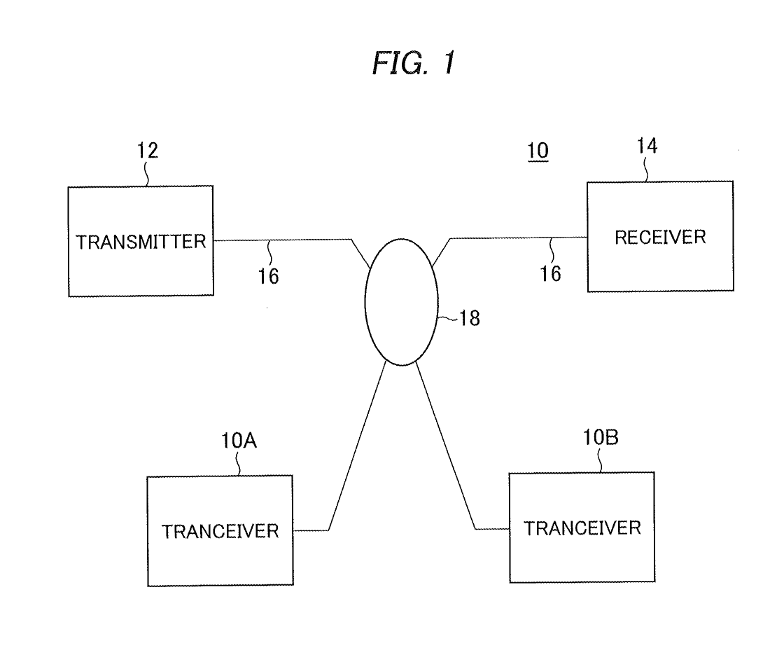

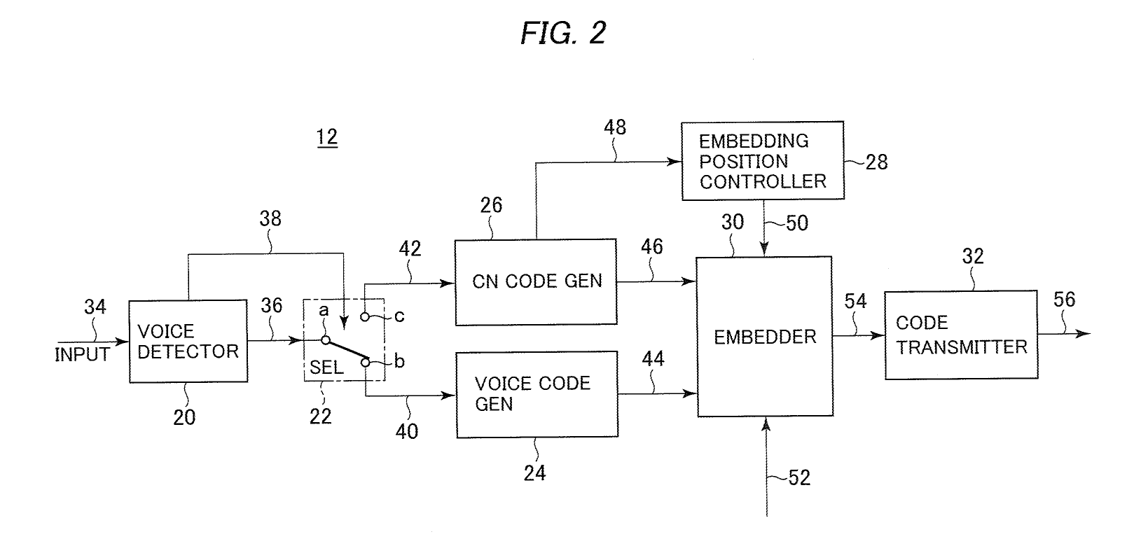

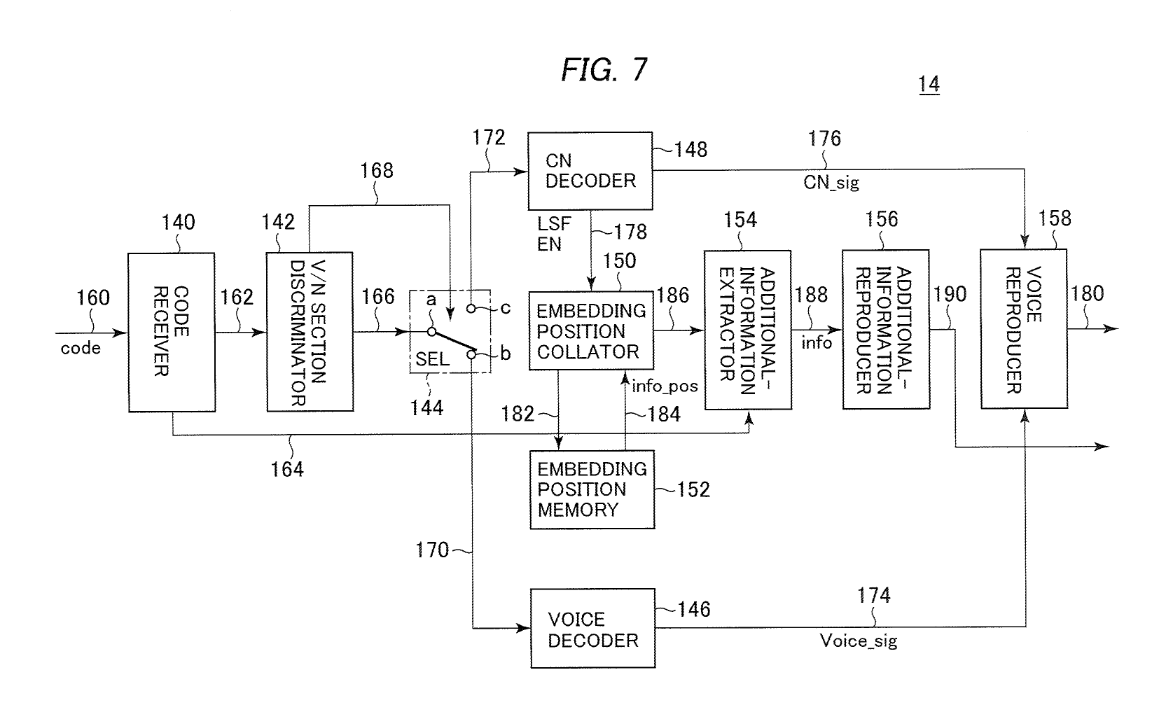

Preferred embodiments of a voice communication system according to the present invention will be described in detail with reference to the accompanying drawings. Referring first to FIG. 1, a preferred embodiment of the voice communication system according to the invention is generally designated with a reference numeral 10. The voice communication system 10 includes a transmitter 12 including the function of voice encoder, a receiver 14 including a function of voice decoder, and transmitter-receivers 10A and 10B, which are interconnected to a telecommunications network 18. The configurations of the transmitter 12 and receiver 14 are shown more particularly in FIGS. 2 and 7, respectively.

The transmitter 12 is generally adapted such that when an input signal 34, FIG. 2, is from a voice section of a signal stream to be transmitted it is used to generate a voice code and when the input signal 34 is from a background noise section of the steam it is used to extract a noise feature parameter, for use in reconstructing the signal in the background noise section on a destination of the input signal in the network system 10, and to encode the parameter to thereby generate a noise code, which will be used to determine an embedding position of the signal stream where additional information is to be embedded according to a predetermined correspondence relationship between the noise feature parameter and embedding positions where additional information is to be embedded, thus the additional information being embedded at the embedding position thus determined of the voice or noise code so as to be sent out to the destination, or receiver 14.

The receiver 14 is generally adapted such that when the code received from the transmitter 12 is determined as from a voice section it is decoded into a voice signal and when the code is determined as from a background noise section it is used to obtain the noise feature parameter therefrom to generate a noise signal approximating the background noise characteristic of the transmitter 14 while the noise feature parameter thus obtained is used as index key information to obtain from the correspondence relationship embedding position information which is associated with the embedding positions of the additional information thus embedded so that the bit values of bit positions associated with the obtained embedding position information are extracted to form a stream of the so-extracted bit values representative of the additional information. The decoded voice and generated background noise signals will be reproduced in the form of audible sound. The embedding positions of additional information are thus controlled according to the background noise characteristic, so that additional information embedded in a code to be transmitted would not cause the sound quality to be impaired but the communication bandwidth can be effectively utilized.

Portions or elements not directly relevant to understanding the present invention are omitted from being described or shown. In the description, signals or data are specified by reference numerals attached to connections where they appear.

As seen from FIG. 1, the voice communication system 10 includes the transmitter 12 and the receiver 14 and is adapted to operate under the Adaptive Multi-Rate (AMR) scheme for speech encoding. The transmitter 12 is included in a transmission system for voice communications employing a voice coding apparatus in accordance with the present invention. The transmitter 12 has a function of encoding voice signals and information other than voice signals. Such information may often be referred to as non-voice, voice-related or additional information. The transmitter 12 transmits data 16 including encoded voice signals and additional information toward the receiver 14 over a telecommunications network 18, which may bean InternetProtocol (IP) network, for example. The receiver 14 is included in a receiving system for speech communications employing a voice decoding apparatus in accordance with the invention for decoding voice signals. The receiver 14 is adapted to decode the supplied data 16, and reproduces the voice therefrom in the form of audible sound as well as restores additional information. The transmitter-receivers 10A and 10B involved in a transmission-reception system may have both functions of the transmitter 12 of a transmission system and the receiver 14 of a reception system.

With reference to FIG. 2, the transmitter 12 includes a voice detector 20, a selector (SEL) 22, a voice code generator 24, a comfortable-noise (CN) code generator 26, an embedding position controller 28, an information embedder 30, and a code transmitter 32, which are interconnected as depicted.

The transmitter 12 may be implemented by a processor system including a central processing unit (CPU), not shown, and computer program sequences stored in the system to be executed by the CPU, the program sequences controlling the system to operate as the voice coding apparatus. The transmitter 12 can be functionally represented as in FIG. 2. The program sequences may be stored on a computable-readable storage medium such as a nonvolatile semiconductor memory or optical disk. The program sequences may be read out from the storage to be executed on the system at a user's request, for example, to perform the functions as intended.

The voice detector 20 has a function of making a determination at predetermined intervals of time as to whether the input signal 34 carries voice or background noise. The input signal 34 may be a signal containing voice and possible background noise captured by a microphone, not shown, and digitized. When a digital voice signal is given as the input signal 34 (input in the figure), the voice detector 20 discerns the type of the signal, i.e. voice or noise, at time intervals corresponding to a packet frame, e.g. every 20 ms with the illustrative embodiment. For this determination, any of existing schemes can be used. For example, 3G TS 26.094 Version 3.0.0 described in the introductory part of this specification is available for this method of determination. The voice detector 20 passes the input signal 34 in the form of output signal 36 to the selector 22. In addition, the voice detector 20 generates a switching signal 38 according to the result of the determination on the input signal 34 and supplies the signal 38 to a control terminal of the selector 22.

The selector 22 is operative in response to the switching signal 38 to switch the destination of the supplied output signal 36 in the transmitter 12, i.e. the voice code generator 24 or comfortable-noise code generator 26. More specifically, when the selector 22 receives the switching signal 38 having its signal state corresponding to speech, the selector 22 is switched to its one output terminal b to pass the input signal 36 on its input port a as a voice signal 40 to the voice code generator 24. When the selector 22 receives the switching signal 38 having its signal state corresponding to background noise, it is switched to its other output terminal c to pass the input signal 36 as a noise signal 42 to the comfortable-noise code generator 26.

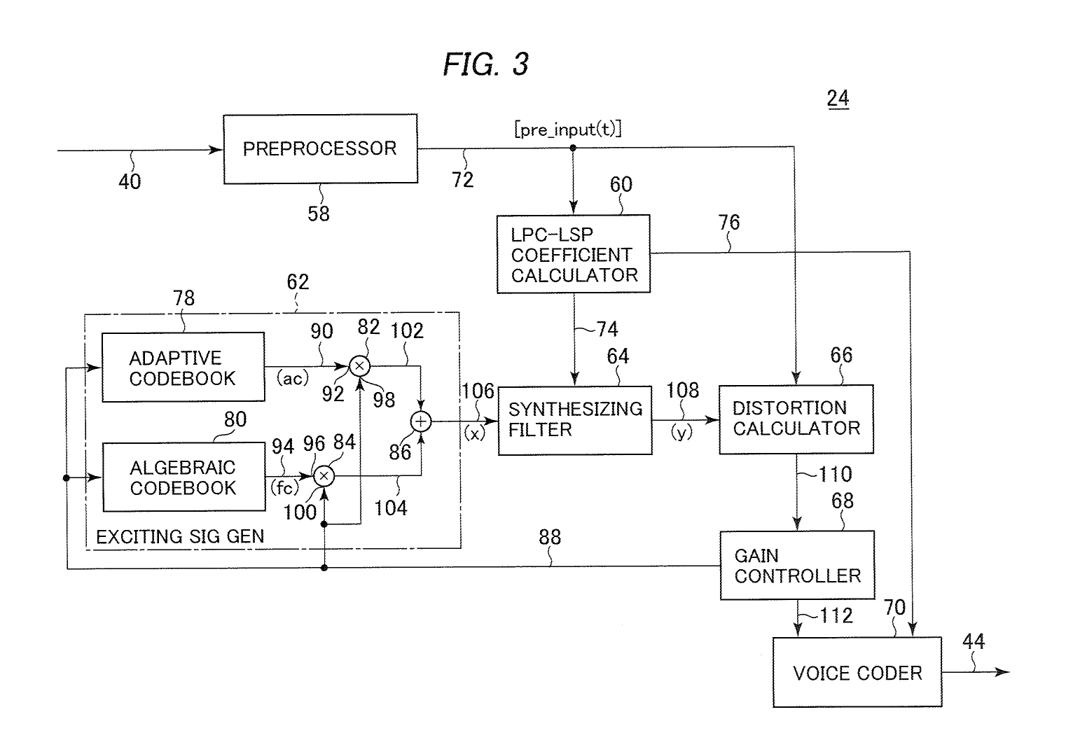

The voice code generator 24 is adapted for receiving the voice signal 40 coming from input signal 36 thus switched, and generating a corresponding voice code Voice_code. The voice code generator 24 supplies the voice code Voice_code (44) thus generated to the information embedder 30. An example of configuration of the voice code generator 24 will be described in detail later on with reference to FIG. 3. This specific configuration may comply with the regulation, 3G TS 26.092 Version 3.0.1.

The comfortable-noise (CN) code generator 26 has a function of generating a comfortable-noise code CN_code (46) when the input signal 34 is determined to be background noise. In the context, the comfortable noise is pseudo-background noise that is to be produced in order to prevent the recipient from erroneously being aware of an interruption of telephone communication otherwise going on during compression coding in a silent state. When the CN code generator 26 of the transmitter 12 generates a feature quantity of background noise in the form of code and sends the latter toward the receiver 14, the receiver 14 generates noise approximating the background noise characteristic and outputs the noise as comfortable noise.

To the comfortable-noise code generator 26, applied can be the regulation, 3GPP TS 26.101 Version 3.3.0, for example. The CN code generator 26 is operative under the applied regulation to calculate two types of feature quantities, i.e. the average LSF (Line Spectral Frequency) parameter vector indicating the frequency characteristic of background noise and the average logarithmic frame energy EN indicating the level of background noise, to encode the feature quantities. The CN code generator 26 uses the average LSF parameter vector LSF and average logarithmic frame energy EN to generate a comfortable-noise code CN_code (46) from the background noise 42. The CN code generator 26 outputs the generated average LSF parameter vector LSF and average logarithmic frame energy EN as feature quantities 48 to the embedding position controller 28. As a specific method of generating the comfortable-noise code CN_code, a method using Table A.2 of 3G TS 26.092 Version 3.0.1 may be utilized. As will be described later in detail, the receiver 14 generates random numbers and adjusting the frequency characteristic and level according to the average LSF parameter level and average logarithmic frame energy, respectively, to thereby obtain comfortable noise having the characteristic of the background noise of the transmitter 12 reflected thereon.

The embedding position controller 28 is adapted for using the feature quantities 48 calculated by the comfortable-noise code generator 26 to produce a control signal specifying an information embedding position. The embedding position controller 28 uses the average LSF parameter vector LSF and average logarithmic frame energy EN to produce positional information or an indication signal info_pos (50) which defines an information embedding position, and outputs the signal info_pos (50) to the information embedder 30. The embedding positions are controlled or determined only within background noise sections of a signal stream.

The information embedder 30 has a function of multiplexing either the voice code Voice_code (44) or comfortable-noise code CN_code (46) onto a code stream and embedding externally given additional information 52 at the positions, specified by the indication signal info_pos (50), in the multiplexed code stream. What is meant by “multiplexing” is that a parameter discriminating between voice code Voice_code and comfortable-noise code CN_code is included in a code stream at predetermined intervals. The information embedder 30 is adapted to embed, during each background noise section, the additional information 52 at the determined embedding positions info_pos, and, during each voice section, the additional information 52 at the embedding positions info_pos to which the embedding positions info_pos determined in the latest background noise sections are “exploited”.

The “exploitation” in the context means that voice sections are processed frame by frame and in such a frame the additional information 52 is embedded at the embedding bit position in an octet defined by the embedding position info_pos. In general, in voice sections a signal includes voice having background noise superimposed thereto, so that it is difficult to specify which positions are appropriately adapted for embedding voice. However, the embedding position controller 28 is adapted to determine which positions are preferable for embedding according to the superimposed background noise. Therefore, during voice sections, embedding positions info_pos determined in the latest background noise sections are also exploited. The information embedder 30 supplies the code transmitter 32 with the multiplexed code 54 having the additional information 52 thus embedded at the specified positions.

The code transmitter 32 has a function of transmitting the code code (56) multiplexed with the voice code Voice_code or the comfortable-noise code CN_code having the additional information 52 thus embedded at the embedding positions info_pos to a destination of the input signal 14 in the network system 10, e.g. the receiver 14. The code transmitter 32 transmits the code code (56) multiplexed with the voice code Voice_code (44) or the comfortable-noise code CN_code (46) toward the receiver 14.

The aforementioned constituent elements will be described in turn. First, with reference to FIG. 3, the voice code generator 24 comprises a preprocessor 58, an LPC (Linear Predictive Coding)-LSP (Line Spectral Pairs) coefficient calculator 60, an exciting signal generator 62, a synthesizing filter 64, a distortion calculator 66, a gain controller 68, and a voice coder 70, which are interconnected as illustrated.

The voice code generator 24 has a function of analyzing input voice to extract parameters defining the vibration of the vocal cords and vocal tract characteristics of human beings, and encoding the parameters. Such parameters may be established by a human utterance mechanism simulating the vibrations of the human vocal cords as a sound source and the control of the human vocal tract over the frequency characteristic. Particularly, parameters defining the vibration of the vocal cords, described later, may be obtained by the exciting signal generator 62. The parameters defining the vocal tract characteristics may be extracted by the LPC-LSP coefficient calculator 60.

The preprocessor 58 has a function of removing the DC component from the input signal input (40) determined to be of voice and reducing the amplitude of the signal to prevent overflowing. This function may be implemented by, for example, division by two. The preprocessor 58 outputs a processed signal pre_input (72) to the LPC-LSP coefficient calculator 60 and the distortion calculator 66.

The LPC-LSP coefficient calculator 60 is adapted for using the signal pre_input (72) to calculate the linear prediction coefficient lpc_coef and LSP coefficient lsp_coef. The calculator 60 delivers the calculated linear prediction coefficient 74 and calculated LSP coefficient 76 to the synthesizing filter 64 and voice coder 70, respectively.

The exciting signal generator 62 has a function of generating an exciting signal x by the processing of “searching” for the optimum exciting signal. The term “search” will be described later on. To implement this function, the generator 62 includes an adaptive codebook 78, an algebraic codebook 80, gain multipliers 82 and 84, and an adder 86, which are interconnected as shown.

The adaptive codebook 78 has a function of extracting sound source signal waveforms ac having regularity such as speech pitch from past input signals to store data of the extracted waveforms, and of reading out, when searching, candidates associated with a control signal 88 provided from the gain controller 68 among the waveform data of sound source signals thus stored. The codebook 78 supplies the waveform data ac (90) about the sound source signals read out as the candidates to one port 92 of the gain multiplier 82.

The algebraic codebook 80 has a function of storing plural sets of waveform data in the form of signal waveforms fc which have pulses at predetermined positions in order to reproduce sound signal waveforms and noises having no definite regularity, and of reading out, when searching, candidates associated with the control signal 88 provided from the gain controller 68 among the signal waveform data thus stored. The algebraic codebook 80 develops the readout signal waveform data fc (94) as the candidate to one port 96 of the gain multiplier 84.

The gain multiplier 82 has a function of multiplying the sound source signal waveform data ac thus developed from the adaptive codebook 78 by a weighting gain ag (88) given from the gain controller 68. The gain multiplier 84 also has a function of multiplying the signal waveform data fc developed from the algebraic codebook 80 by the weighting gain fg (88) provided from the gain controller 68. The weighting gain ag (88) and the weighting gain fg (88) are supplied to the other port 98 of the gain multiplier 82 and the other port 100 of the gain multiplier 84, respectively.

The adder 86 has a function of adding the resultant output 102 from the gain multiplier 82 to the resultant output 104 from the gain multiplier 84. The adder 86 outputs the result of the addition in the form of exciting signal 106 (x) to the synthesizing filter 64.

As is clear from the description provided so far, the exciting signal x(t) is given by

x(t)=ag×ac(t)+fg×fc(t) (1)

where the variable t indicates time. The right side of Expression (1) includes four parameters, ac(t), fc(t), ag and fg, which may be varied. In the context, the term “search” means that the values of the four parameters providing the highest evaluation value, described later, are determined. The exciting signal x(t) is thus defined by the values obtained by the search at time t.

For this search, the exciting signal generator 62 plays an important role indeed. However, as is clear from FIG. 3, since the synthesizing filter 64, distortion calculator 66 and gain controller 68 supply various signals to the exciting signal generator 62, it can be seen that those three components also take the important functions for this search.

The synthesizing filter 64 has a function of convolving the exciting signal 106 [x (t)] with the linear prediction coefficient lpc_coef (74) to thereby obtain a local, decoded signal which would be produced when decoding is done by means of the candidate exciting signal x (t). That is, the synthesizing filter 64 synthesizes a signal y (t) associated with the preprocessed signal pre_input. The filter 64 outputs the obtained signal 108 [y (t)] to the distortion calculator 66.

The distortion calculator 66 has a function of calculating an error between the preprocessed signal pre_input (t) (72) and the local, decoded signal y (t) (108). The calculator 66 delivers the resultant error dist (110) thus calculated out to the gain controller 68.

The gain controller 68 has a control function of switching candidate parameters such that the four parameters ac (t), fc (t), ag and fg that render the supplied error dist (110) minimized can be determined. The gain controller 68 may be adapted to switch candidate parameters such that not only parameters rendering the minimum error but also parameters providing values less than a predetermined threshold are selected. The gain controller 68 functions as producing the control signal 88 for controlling the codebooks 78 and 80 of the exciting signal generator 62, and as supplying weighting gains ag and fg to the gain multipliers 82 and 84, respectively. In addition, the controller 68 produces the four parameters ac(t), fc(t), ag and fg (112) determined when the error dist (110) is minimized. The controller 68 feeds the voice coder 70 with the four parameters ac(t), fc(t), ag and fg (112) thus determined when the error dist (110) is minimized.

The voice coder 70 is adapted for using the parameters 112 and LSP coefficients lsp_coef (76) to generate a voice code Voice_code (44) to be transmitted to a voice decoder 146, FIG. 146, of the receiver 14. The voice coder 70 outputs the generated voice code Voice_code (44) to the information embedder 30.

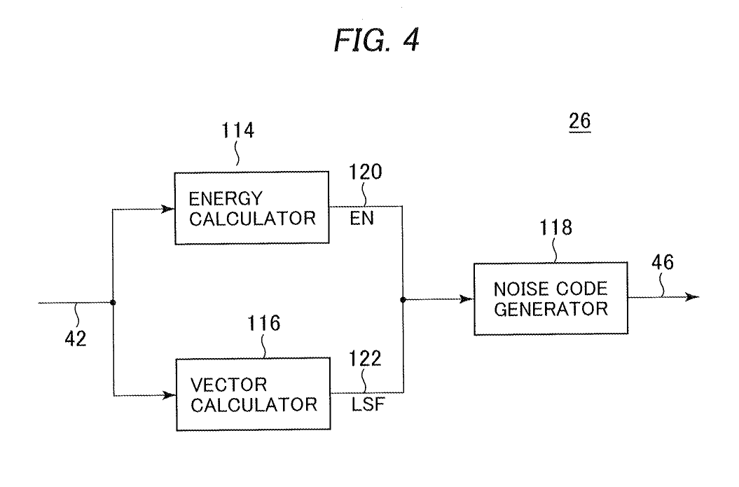

Now, with reference to FIG. 4, an example of configuration of the comfortable-noise code generator 26 will be described. The code generator 26 is designed in accordance with the aforementioned regulation, 3G TS 26.092. The code generator 26 includes an energy calculator 114, a vector calculator 116, and a noise code generator 118, which are interconnected as shown.

The energy calculator 114 is adapted to receive the input signal 42 and calculate an average logarithmic frame energy EN based on the input signal 42. In calculating the average logarithmic frame energy, use may be made of a method set forth in, for example, Section 5.2 of the regulation, 3G TS 26.092. The energy calculator 114 provides data of the calculated average logarithmic frame energy EN (120) to the noise code generator 118.

The vector calculator 116 serves to receive the input signal 42 and calculate the average LSF parameter vector LSF based on the input signal 42. In calculating the average LSF parameter vector, use may be made of a method set forth in, for example, Section 5.1 of the regulation, 3G TS 26.092. The vector calculator 116 transfers information on the calculated average LSF parameter vector LSF (122) to the noise code generator 118.

The noise code generator 118 has a function of using the average logarithmic frame energy EN and average LSF parameter vector LSF to generate a comfortable-noise code CN_code. In generating the comfortable-noise code, use may be made of, for example, a method utilizing Table A.2 of the regulation, SG TS 21101. The noise code generator 118 supplies the generated comfortable-noise code CN_code (46) to the information embedder 30.

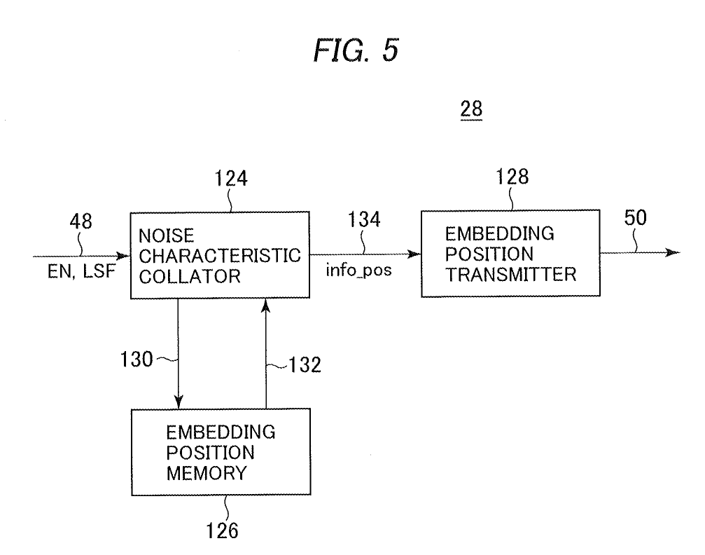

FIG. 5 shows the embedding position controller 28 including a noise characteristic collator 124, an embedding position memory 126, and an embedding position transmitter 128, which are interconnected as depicted.

The noise characteristic collator 124 has a function of using the values 48 of the average logarithmic frame energy EN and average LSF parameter vector LSF calculated by the comfortable-noise code generator 26 to form collation or index key information 130 to supply the latter to the embedding position memory 126 to thereby fetch corresponding embedding position information info_pos (134) from the embedding position memory 126. The collator 124 delivers the supplied values 48 of the average logarithmic frame energy EN and average LSF parameter vector LSF to the embedding position memory 126. The values 48 of the average logarithmic frame energy EN and average LSF parameter vector LSF are thus collation information 130.

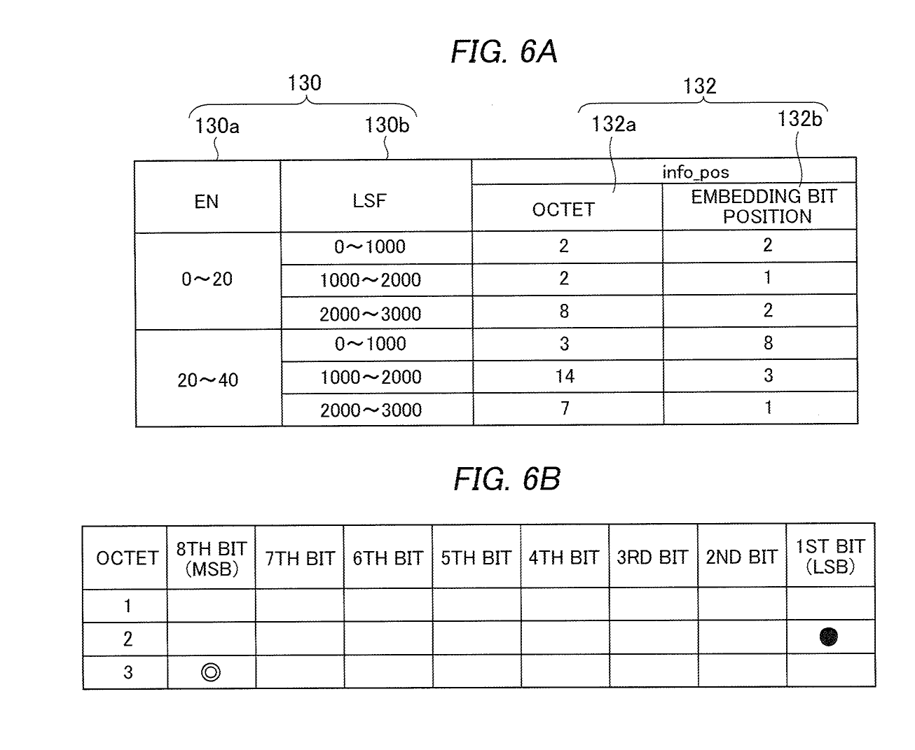

The embedding position memory 126 has a function of storing, in a table form, data of a correspondence relationship of the range 130a, FIG. 6A, of values of the average logarithmic frame energy EN and the range 130b of values of the average LSF parameter vector LSF to the information embedding positions, and hence to the information storage locations of the memory 126. A specific example of the memory fields of the embedding position memory 126 is shown in FIGS. 6A and 6B. For example, if the values of the average logarithmic frame energy EN (130a) and the average LSF parameter vector LSF (130b) are “15” and “1200”, respectively, then the information-embedding position (2, 1) that represents “second octet, first bit position for embedding” is obtained as seen from FIG. 6A to be developed as the embedding position information info_pos (132).

The information embedding position is defined herein as a position where the sound quality deterioration is minimal within the ranges of values of the average logarithmic frame energy EN and average LSF parameter vector LSF associated therewith. Such positions are determined in advance through simulation, for example, and stored in the memory 126.

According to FIG. 6A, the above-described position “second octet, first bit position for embedding” is defined by the embedding position info_pos (132) in a case where the values 130a and 130b of the average logarithmic frame energy EN and average LSF parameter vector LSF fall in the ranges of 0≦EN<20 and 1000≦LSF<2000, respectively, to correspond to a set of values (2, 1) of the octet 132a and bit position for embedding 132b. The “second octet, first bit position for embedding” is the position indicated in FIG. 6B by a black dot in the frame. In a case where the values 130a and 130b of the average logarithmic frame energy EN and average LSF parameter vector LSF fall in the ranges of 20≦EN<40 and 0≦LSF<1000, respectively, the embedding position info_pos (132) is defined by the position “third octet, eighth bit position for embedding”, which is the position indicated by a bullseye in the frame of FIG. 6B. In this way, the noise characteristic collator 124 obtains embedding position information info_pos (132) fetched with the collation information from the embedding position memory 126, and delivers embedding position information info_pos (134) representative of the obtained embedding position information info_pos (132) to the embedding position transmitter 128.

According to the AMR, the structure of the voice code Voice_code is dependent upon the bit rates of the signal to be transmitted. If the transmitter 12 of the present embodiment is designed to cope with plural bit rates, the correspondence relationship tables such as shown in FIGS. 6A and 6B may be prepared specifically to the bit rates.

The embedding position transmitter 128 has a function of producing the embedding position information info_pos corresponding to the characteristic of the background noise, obtained by the noise characteristic collator 124, to the information embedder 30. The transmitter 128 transfers embedding position information 50 representative of the supplied embedding position information info_pos to the information embedder 30.

The receiver 14 will be described with reference to FIG. 7. The receiver 14 includes a speech decoding function, which may be implemented by a processor system including a CPU and computer program sequences stored in the system to be executed by the CPU. Anyway, the receiver 14 can be functionally represented in the form of schematic block diagram of FIG. 7. The program sequences may be stored on a computable-readable storage medium such as an optical disk or a nonvolatile semiconductor memory, and may be read out from the storage medium at a user's request, for example, and executed. In this connection, the word “circuit” or “device” may be understood not only as hardware, such as an electronics circuit, but also as a function that may be implemented by software installed and executed on a computer.

The receiver 14 includes a code receiver 140, a voice/noise (V/N) section discriminator 142, a selector 144, a voice decoder 146, a comfortable-noise decoder 148, an embedding position collator 150, an embedding position memory 152, an additional-information extractor 154, an additional-information reproducer 156 and a voice reproducer 158, which are interconnected as shown.

The code receiver 140 is adapted to receive a code code (160) sent by the transmitter 12. The code, code, includes the speech code Voice_code and comfortable-noise code CN_code. The code receiver 140 receives the code code (160) from the transmitter 12 and supplies the received code code to the V/N section discriminator 142 and additional-information extractor 154 over the connections 162 and 164, respectively.

The V/N section discriminator 142 serves as passing the supplied code, code, therethrough and also as making a decision as to whether the supplied code, code, is in a voice section or in a background noise section by referring to parameters indicating voice sections of the voice code Voice_code and background noise sections of comfortable-noise code CN_code contained in the code, code. More specifically, the discriminator 142 sends the supplied code code (162) over the connection 166 to the selector 144. The discriminator 142 makes a decision on whether the supplied code code (162) is in a voice section or background noise section to produce the switching signal 168 indicative of the result of the decision to the control terminal of the selector 144.

The selector 144 is operative in response to the switching signal 168 to selectively switch the destination of the supplied code code (166) in the receiver 14, namely the voice decoder 146 or comfortable-noise decoder 148. When the switching signal 168 determined to be in a voice section is supplied, the selector 144 switches to the terminal band conveys a voice section signal 170 representing the code code (166) to the voice decoder 146. When the switching signal 168 determined to be of background noise is supplied, the selector 144 switches to the terminal c and passes a noise section signal 172 indicative of the code code (166) to the comfortable-noise decoder 148.

The voice decoder 146 has a function of performing voice decoding coping with the coding scheme of the voice code generator 24 in the transmitter 12 on the signal 170 when it is in a voice section. In the voice decoding, the voice decoder 146 first uses the parameters of signal sources ac and fc and weighting gains ag and fg contained in the voice section signal 170 determined as a voice code Voice_code to reconstruct the exciting signal. The voice decoder 146 then convolves by a synthesizing filter, not shown, the exciting signal with the linear prediction coefficient lpc/coef calculated from the LSP coefficient lsp_coef contained in the voice section signal 170 to thereby reconstruct the voice signal. The decoder 146 in turn performs formant enhancement to improve the audibility and passes the signal through a high-pass filter, not shown, which removes DC components. Finally, the decoder 146 restores the original amplitude compressed by the preprocessor 58 shown in FIG. 3 to thereby obtain final output voice Voice_sig. In order to restore the compressed amplitude to its original one, the amplitude may preferably be multiplied, for example, by two to expand the amplitude. The speech decoder 146 outputs the restored output voice Voice_sig (174) to the voice reproducer 158.

The comfortable-noise decoder 148 has a function of generating random noise to adjust the frequency characteristic based on the average LSF parameter vector LSF contained in the background noise section signal 172 when it is in a background noise section in the form of comfortable-noise code CN_code, and to adjust the level based on the average logarithmic frame energy EN contained in the comfortable-noise code CN_code, thereby obtaining the comfortable-noise signal CN_sig (176) having the characteristic of the background noise on the transmitter side reflected thereon. The comfortable-noise decoder 148 also has a function of supplying the embedding position collator 150 with the average LSF parameter vector LSF and average logarithmic frame energy EN (178) taken out from the background noise section signal 172. The comfortable-noise decoder 148 delivers the comfortable noise signal CN_sig (176) to the voice reproducer 158 and the average LSF parameter vector LSF and average logarithmic frame energy EN (178) to the embedding position collator 150.

The voice reproducer 158 has a function of reproducing the output voice Voice_sig (174) in each voice section and the comfortable noise signal CN_sig (176) in each background noise section. The voice reproducer 158 outputs the output voice Voice_sig (174) or comfortable noise signal CN_sig (176) in the form of audible output voice 180.

Now, the embedding position collator 150 has a function of passing the average LSF parameter vector LSF and average logarithmic frame energy EN (178) supplied from the comfortable-noise decoder 148 to the embedding position memory 152 to thereby make an inquiry using the embedding position information info_pos as collation information, and obtaining embedding position information info_pos in reply from the embedding position memory 152 to provide the additional-information extractor 154 with the obtained embedding position information info_pos. When the embedding position collator 150 receives the average LSF parameter vector LSF and average logarithmic frame energy EN (178) from the comfortable-noise decoder 148, the collator 150 delivers the supplied average LSF parameter vector LSF and average logarithmic frame energy EN (178) as collation information 182 to the embedding position memory 152. The embedding position collator 150 in turn acquires from the embedding position memory 152 embedding position information info_pos (184) that is associated with the collation information 182. The embedding position collator 150 transfers data of embedding position info_pos (186) representing the acquired embedding position information info_pos (142) to the additional-information extractor 154.

The embedding position memory 152 is adapted for storing, in a table form, data of a correspondence relationship of the ranges of values of the average logarithmic frame energy EN and average LSF parameter vector LSF to information embedding positions in the same way as the embedding position memory 126 of the transmitter 12 shown in FIGS. 6A and 6B.

The additional-information extractor 154 has a function of extracting the bit values of bit positions, indicated by the embedding position information info_pos (186), of the code code (164) received by the code receiver 140, i.e. voice code Voice_code and comfortable-noise code CN_code. Those bit values will in combination represent the additional information. The extractor 154 outputs additional information info (188) representing the extracted bit values to the additional-information reproducer 156.

The additional-information reproducer 158 has a function of assembling the bit values extracted by the additional-information extractor 156 into a stream of bits representing additional information 190.

Embedding and extraction of additional information performed by the transmitter 12 and the receiver 14 will be described. The input digital voice signal input (34) is determined by the voice detector 20 as to whether it is voice or background noise at predetermined intervals, e.g. every 20 ms, in such a fashion that the voice section signal 40, when determined as such, is supplied to the voice code generator 24, while the background noise section signal 42, when determined as such, is supplied to the comfortable-noise code generator 26.

In response to the voice section signal 40, the voice code generator 24 generates a voice code Voice_code. The generated voice code Voice_code (44) is fed from the voice code generator 24 to the information embedder 30. On the other hand, in response to the background noise section signal 42, the comfortable-noise code generator 26 generates a comfortable-noise code CN_code. The generated code CN_code (46) is transferred from the comfortable-noise code generator 26 to the information embedder 30.

The average logarithmic frame energy EN and average LSF parameter vector LSF (48) calculated by the comfortable-noise code generator 26 for the purpose of generating the comfortable-noise code CN_code are supplied to the embedding position controller 28. In the embedding position controller 28, the values 48 of the average logarithmic frame energy EN and average LSF parameter vector LSF are input to the noise characteristic collator 124 to be used as collation information 130, which is in turn input to the embedding position memory 126. From the embedding position memory 126, embedding position information info_pos (132) associated with the collation information 130 is read out to be developed from the embedding position transmitter 128 as an ultimate output signal 50 of the embedding position controller 28.

In the information embedder 30, if the result of the decision made by the voice detector 20 reveals that the input signal 34 is in a voice or a noise section, additional information 52 is embedded at positions designated as optimum by the embedding position information info_pos (50) of a voice code Voice_code or comfortable-noise code CN_code, respectively.

The information embedder 30 multiplexes the voice code Voice_code or comfortable-noise code CN_code having the additional information 52 thus embedded at the positions indicated by the embedding position information info_pos (50) to produce the code code (54) and transfer the latter to the code transmitter 32. The code transmitter 32 transmits the code code (56) as the output of the transmitter 12 toward a destined communication terminal involved in the communication.

The code, code, sent from the transmitter 12 are received as a received code code (160) by the code receiver 140 of the receiver 14 that is involved as a destination in the communication. The receiver 140 supplies the codes code (162) and (164) to the V/N section discriminator 142 and the additional-information extractor 154, respectively. The V/N section discriminator 142 passes the supplied code code (162) to the selector 144, while comparing a signal in a temporal section contained in the supplied code code (162) with parameters to thereby make a decision as to whether the temporal section is a voice or a background noise section, thus producing the switching signal 168 accordingly. One of the parameters used herein is in connection with a signal indicating a section of voice code Voice_code. The other parameter is in connection with a signal of a section of comfortable-noise code CN_code. The generated switching signal 168 is supplied to the selector 144, which in turn transfers the code code (162) to a destination in the receiver 14 selected in response to the switching signal thus generated according to the result of a decision, namely the voice decoder 146 or comfortable-noise decoder 148.

More specifically, in voice sections, voice decoding appropriate for the voice code generator 24 is performed by the voice decoder 146, thus obtaining output voice Voice_sig (174). In background noise sections, the comfortable-noise decoder 148 generates random numbers to adjust the frequency characteristic based on the average LSF parameter vector LSF contained in the comfortable-noise code CN_code, and to adjust the level based on the average logarithmic frame energy EN contained in the comfortable-noise code CN_code, thereby obtaining a comfortable noise signal CN_sig (176) which has the characteristic of the background noise on the transmitter side reflected thereon. The voice reproducer 158 produces an output voice Voice_sig or a comfortable noise signal CN_sig if the V/N section discriminator 142 determines that the section is a voice section or a noise section, respectively.

The comfortable-noise decoder 148 supplies the fetched average LSF parameter vector LSF and average logarithmic frame energy EN (178) to the embedding position collator 150. Via the embedding position collator 150, the embedding position memory 152 receives as collation information 182 the values of the average LSF parameter vector LSF and average logarithmic frame energy EN. In response, the embedding position memory 152 develops embedding position information info_pos (184) corresponding to the collation information 184 to the embedding position collator 150. The embedding position collator 150 delivers the embedding position information info_pos (184) thus obtained to the additional-information extractor 154 over a connection 184.

The additional-information extractor 154 extracts the bit values of the positions indicated by the embedding position information info_pos of the code code (164) received by the code receiver 140. The additional-information reproducer 156 assembles the bit values into a stream of bits representing the extracted additional information to output the additional information 190.

According to the present embodiment, both transmitter 12 and receiver 14 hold in the respective embedding position memories information of the same configuration referenceable by means of background noise parameters. Thus, additional information can be embedded in embedding positions where the deterioration is smaller according to the background noise characteristic to be transmitted together with speech information, the receiver 14 accurately reproducing signals in voice and background noise sections from the transmitted signal. Therefore, additional information can be embedded in frames of voice code or comfortable-noise code with sound quality deterioration always kept minimized irrespective of the background noise characteristic. Thus, the additional information can be transmitted while maintaining the telephone communication quality at a given level or higher at all times, and the communication bandwidth can be effectively utilized.

The illustrative embodiment described so far is directed to a real-time transmission from the transmitter 12 to the receiver 14 such as a telephone or videoconference facility. The present invention may not be restricted to this specific communication configuration but may be applied to a communication configuration in a broad sense, for example, to storage media which code from the transmitter 12 may be written in and read out from to be decoded by the receiver 14.

Furthermore, in the above-described embodiment, additional information is embedded both in voice code and in comfortable-noise code. Alternatively, additional information may be embedded at least in either one of voice code and comfortable-noise code.

In addition, the above embodiment has the AMR applied to its speech encoding. The invention may not be restricted to this method. Rather, the technical concept of the present invention may be applied to any speech encoding methods in which the signals may be encoded separately between the voice and background noise sections of a signal stream and the feature parameters of background noise encoded can be shared by the transmitter 12 and receiver 14.

Additionally, in the above embodiment, no restrictions may be imposed on the type of embedded additional information. Any arbitrary additional information may be embedded according to designer's needs such as textual information or a feature quantity of speech such as input speech level.

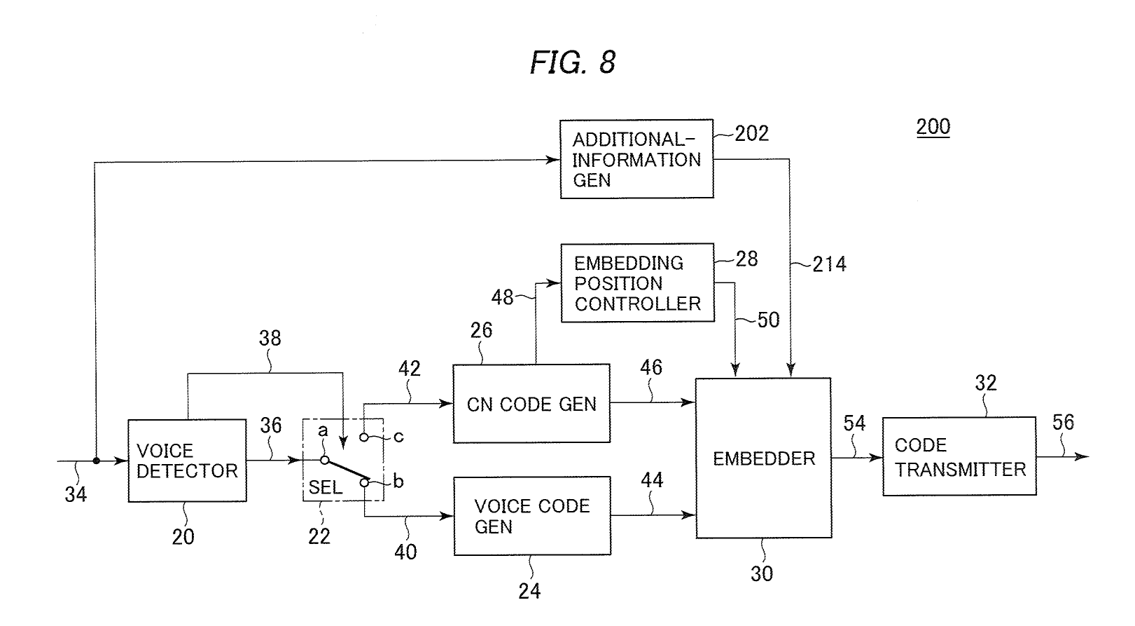

In order to allow information to be embedded which cannot be obtained until the input signal is arithmetically processed in some way such as a feature quantity of speech, it may be sufficient to provide a functional section for extracting voice feature quantities to produce additional information. With reference to FIG. 8, a transmitter according to such an alternative embodiment will be described which is generally designated with a reference numeral 200 and includes an additional-information generator 202 in addition to the voice detector 20, selector 22, voice code generator 24, comfortable-noise code generator 26, embedding position controller 28, information embedder 30 and code transmitter 32. Like components are designated with the same reference numerals and their redundant description will be refrained from.

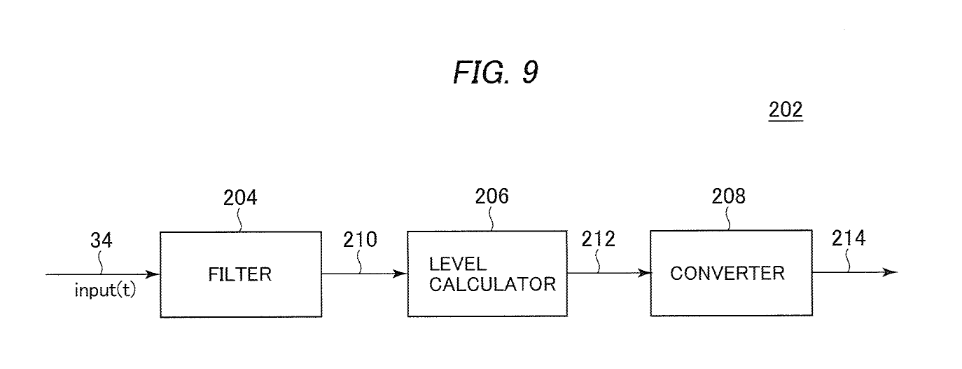

The current alternative embodiment is directed to an example in which the speech level in a certain frequency band is used as a voice feature quantity. The additional-information generator 202 is adapted to receive the input signal 34, which is provided frame by frame in operation. Each frame of the input signal 34 includes a plurality (N) of sampled data items. The additional-information generator 202 has an additional function of extracting voice feature quantities. To implement these functions, the additional-information generator 202 includes a filter 204, a level calculator 206, and a converter 208, which are interconnected as shown in FIG. 9. The additional-information generator 202 is connected to receive the input signal input (t) (34) which is composed of individual frames each of which consists of N sampled data items 34.

The filter 204 has a function of extracting a predetermined frequency component from the input signal 34. For example, the filter 204 may be, for example, a high-pass filter that passes frequency components equal to or higher than 4 kHz. The filter 204 of the alternative embodiment has a function of performing a convolution operation as given by:

fil_out(t)=FILTER_COEF*input(t) (2)

where the coefficient FILTER_COEF is a filter coefficient for extracting components in a predetermined frequency band, the asterisk (*) denotes a convolution operation, and a signal fil_out (t) is a signal to be operated by convolution. The filter, or convolution calculator, 204 outputs a signal fil_out (t) (210) carrying extracted components equal to or higher than 4 kHz to the level calculator 206.

The level calculator 206 has a function of calculating out the signal level of the extracted components. The level calculator 206 computes the average level LV (212) of the convolved signal. That is, the average level LV is the arithmetic average of absolute values of fil_out(t) within frames and computed using:

$$LV = \frac{{\sum }_{i = 1}^{N} \vert fil\_out ( i ) \vert}{N} \qquad ( 3 )$$

The level calculator 206 outputs the calculated average level LV (212) to the converter 208.

It is to be noted that the average level may not be restricted to the arithmetic average using Expression (3). The average level may instead be the average of squared values or weighted average. The computation of the average level may be varied at will by the designer of the system.

The converter 208 has a function of making the calculated signal level of components conform to a desired format appropriate for embedding additional information. In order to allow data of the level to conform to a format the information embedder 30 can deal with for embedding the level data into code, the converter 208 performs a decimal-to-binary conversion of the average level LV (212). The additional-information generator 202 outputs the format-converted average level LV to the information embedder 30 in the form of additional information add_info (214).

The information embedder 30 embeds the received additional information add_info (214) at positions indicated by the embedding position information info_pos (50) specified by the embedding position controller 28 and sends the information to the code transmitter 32. The transmitter 32 transmits toward the receiver 14 a voice-coded signal 56 which has the additional information add-info (214) embedded in at least one of voice and comfortable noise sections.

An application will now be described in which a frequency band is dealt with as a voice feature quantity. First, frequency components to be extracted by a filter operation given by Expression (2) are set to a high frequency range of 4 kHz or higher. Based on the frequency components, additional information is created while frequency components outside this range, i.e. from 0 to 4 kHz, are voice-coded to be sent to the receiver side. The receiver 14 estimates high-frequency components from the decoded voice signal of low-frequency components. The receiver 14 adjusts the estimated high-frequency components so as to be comparable in level with the high-frequency signal embedded in the form of additional information. Thence, the voice signal of the decoded low-frequency components and the level-adjusted high-frequency signal are combined together. The resulting signal in the frequency domain is transformed into a signal in the time domain to reproduce a broad band of speech signal. This can enhance the speech quality even when signals are transmitted over a telecommunications network whose communication bandwidth is restricted to a certain extent.

Description has been made so far on an example of operation of the transmitter 12 performed when a voice feature quantity is used as additional information. As an example of the voice feature quantity, the average level of a certain frequency band is taken. The invention may not be restricted to this example. The illustrative embodiments may be so modified that formant components are obtained by, for example, utilizing a known method of formant extraction according to the need of the designer of the system.

The entire disclosure of Japanese patent application No. 2011-217070 filed on Sep. 30, 2011, including the specification, claims, accompanying drawings and abstract of the disclosure, is incorporated herein by reference in its entirety.

While the present invention has been described with reference to the particular illustrative embodiments, it is not to be restricted by the embodiments. It is to be appreciated that those skilled in the art can change or modify the embodiments without departing from the scope and spirit of the present invention.

What is claimed is:

1. A voice coding apparatus encoding an input signal to generate a code and embedding additional information in the generated code, said apparatus comprising:
a voice detector making a decision as to whether the input signal is in a voice section or in a background noise section and generating a switching signal associated with a result of the decision;
a voice code generator generating a voice code based on the input signal in the voice section;
a noise code generator operative in response to the input signal in the background noise section for extracting a noise feature parameter, which a voice decoder at a destination of the input signal uses to reconstruct the input signal in the background noise section, to encode the extracted parameter to thereby generate a noise code;
a selector operative in response to the switching signal for switching the input signal between said voice code generator and said noise code generator;
an embedding position controller determining an embedding position of the additional information according to the noise feature parameter extracted to control the embedding position; and
an information embedder embedding the additional information at the embedding position of the voice code or noise code determined by said embedding position controller,
the embedding position being set in advance according to a correspondence relationship with the noise feature parameter.

2. The apparatus in accordance with claim 1, further comprising an additional-information generator extracting a feature quantity from the input signal and making the extracted feature quantity conform to a predetermined format to generate the additional information indicating the feature quantity.

3. The apparatus in accordance with claim 2, wherein said additional-information generator includes:
a filter extracting a predetermined frequency component from the input signal;
a level calculator calculating a signal level of the extracted component; and
a converter making the calculated signal level of the component conform to the predetermined format to form the additional information.

4. A non-transitory computer-readable storage medium having a voice encoding program stored thereon, said voice encoding program being executed by a computer to control the computer to function as a voice coding apparatus encoding an input signal to generate a code and embedding additional information into the generated code, said voice encoding program causing the computer to function as:
a voice detector making a decision as to whether the input signal is in a voice section or in a background noise section and generating a switching signal associated with a result of the decision;
a voice code generator generating a voice code based on the input signal in the voice section;
a noise code generator operative in response to the input signal in the background noise section for extracting a noise feature parameter, which a voice decoder at a destination of the input signal uses to reconstruct the input signal in the background noise section, to encode the extracted parameter to thereby generate a noise code;
a selector operative in response to the switching signal for switching the input signal between said voice code generator and said nose code generator;
an embedding position controller determining an embedding position of the additional information according to the noise feature parameter extracted to control the embedding position; and
an information embedder embedding the additional information at the embedding position of the voice code or noise code determined by said embedding position controller,
the embedding position being set in advance according to a correspondence relationship with the noise feature parameter.

5. A voice decoding apparatus extracting additional information from a received code having the additional information embedded therein for restoring a signal intended by a voice coding apparatus at a transmission source, said decoding apparatus comprising:
a voice/noise section discriminator making a decision as to whether the received code is in a voice section or in a background noise section and generating a switching signal associated with a result of the decision;
a voice decoder decoding a voice signal based on the received code in the voice section;
a noise decoder obtaining a noise feature parameter based on the received code in the background noise section and generating a noise signal approximating a background noise characteristic of the voice coding apparatus;
a selector operative in response to the switching signal for switching the received code between said voice decoder and said noise decoder;
a signal reproducer outputting the voice signal and the noise signal obtained by said voice decoder and said noise decoder;
a memory storing in advance a correspondence relationship between the noise feature parameter and an embedding position where the additional information is to be embedded;
an embedding position collator supplying the obtained noise feature parameter as collation information to said memory and collating the embedding position of the additional information associated with the collation information;
an additional-information extractor extracting a bit value lying at the embedding position collated with respect to the received code; and
an additional-information reproducer forming the extracted bit values into a stream of bits to output the additional information.

6. A non-transitory computer-readable storage medium having a voice decoding program stored thereon, said voice decoding program being executed by a computer to control the computer to function as a voice decoding apparatus extracting additional information from a received code having the additional information embedded therein and restoring a signal intended by a voice coding apparatus at a transmission source, said voice decoding program causing the computer to function as:
a voice/noise section discriminator making a decision as to whether the received code is in a voice section or in a background noise section and generating a switching signal associated with a result of the decision;
a voice decoder decoding a voice signal based on the received code in the voice section;
a noise decoder obtaining a noise feature parameter based on the received code in the background noise section and generating a noise signal approximating a background noise characteristic of the voice coding apparatus;
a selector operative in response to the switching signal for switching the received code between said voice decoder and said noise decoder;
a signal reproducer outputting the voice signal and the noise signal obtained by said voice decoder and said noise decoder;
a memory storing in advance a correspondence relationship between the noise feature parameter and an embedding position where additional information is to be embedded;
an embedding position collator supplying the obtained noise feature parameter as collation information to said memory and collating the embedding position of the additional information associated with the collation information;
an additional-information extractor extracting a bit value lying at the embedding position collated with respect to the received code; and
an additional-information reproducer forming the extracted bit values into a stream of bits to output the additional information.

7. A voice communication system comprising a voice coding apparatus encoding an input signal to generate a code and embedding additional information in the generated code, and a voice decoding apparatus extracting the additional information from a received code having the additional information embedded therein for restoring a signal intended by said voice coding apparatus at a transmission source, wherein
said voice coding apparatus comprises:
a voice detector making a decision as to whether the input signal is in a voice section or in a background noise section and generating a first switching signal associated with a result of the decision;
a voice code generator generating a voice code based on the input signal in the voice section;
a noise code generator operative in response to the input signal in the background noise section for extracting a noise feature parameter, which a voice decoder at a destination of the input signal uses to reconstruct the input signal in the background noise section, to encode the extracted parameter to thereby generate a noise code;
a first selector operative in response to the first switching signal for switching the input signal between said voice code generator and said noise code generator;
an embedding position controller determining the embedding position of the additional information according to the noise feature parameter extracted to control the embedding position; and
an information embedder embedding the additional information at the embedding position of the voice code or noise code determined by said embedding position controller,
the embedding position being set in advance according to a correspondence relationship with the noise feature parameter,
said voice decoding apparatus comprising:
a voice/noise section discriminator making a decision as to whether the received code is in a voice section or in a background noise section and generating a second switching signal associated with a result of the decision;
a voice decoder decoding a voce signal based on the received code in the voice section;
a noise decoder obtaining the noise feature parameter based on the received code in the background noise section and generating a noise signal approximating a background noise characteristic of said voice coding apparatus;
a second selector operative in response to the second switching signal for switching the received code between said voice decoder and said noise decoder;
a signal reproducer outputting the voice signal and the noise signal obtained by said voice decoder and said noise decoder;
a memory storing in advance a correspondence relationship between the noise feature parameter and an embedding position where additional information is to be embedded;
an embedding position collator supplying the obtained noise feature parameter as collation information to said memory and collating the embedding position of the additional information associated with the collation information;
an additional-information extractor extracting a bit value lying at the embedding position collated with respect to the received code; and
an additional-information reproducer forming the extracted bit values into a stream of bits to output the additional information.

8. The system in accordance with claim 7, wherein said voice coding apparatus further comprises an additional-information generator extracting a feature quantity from the input signal and making the extracted feature quantity conform to a predetermined format to generate the additional information indicating the feature quantity.

9. The system in accordance with claim 7, wherein said additional-information generator includes:
a filter extracting a predetermined frequency component from the input signal;
a level calculator calculating a signal level of the extracted component; and
a converter making the calculated signal level of the component conform to the predetermined format to form the additional information.
